(19) United States
(12) Patent Application Publication
(10) Pub. No.: US 2015/0056997 A1
(43) Pub. Date: Feb. 26, 2015

(54) METHODS AND APPARATUS FOR IMPROVED CELL RE-SELECTION WITH AUTONOMOUS SEARCH FUNCTION

(71) Applicant: QUALCOMM Incorporated, San Diego, CA (US)

(72) Inventors: Yi SU, San Jose, CA (US); Sundaresan TAMBARAM KAILASAM, San Diego, CA (US); Feilu LIU, San Diego, CA (US); Uzma KHAN, San Marcos, CA (US); Aziz GHOLMIEH, San Diego, CA (US)

(73) Assignee: QUALCOMM Incorporated, San Diego, CA (US)

(21) Appl. No.: 14/102,028

(22) Filed: Dec. 10, 2013

Related U.S. Application Data
(60) Provisional application No. 61/868,920, filed on Aug. 22, 2013.

(51) Int. Cl. H04W 36/08

(52) U.S. Cl. CPC H04W 36/08
USPC 455/436

(57) ABSTRACT

Apparatus and methods are described for identifying candidate cells on at least one frequency, where each of the candidate cells is associated with a cell quality, storing information related to each of the candidate cells in a candidate list, sorting the candidate list, and decoding a master information block (MIB) and one or more system information blocks (SIBs) for a subset of the candidate cells based on the sorting.

### CLAIM OF PRIORITY UNDER 35 U.S.C. §119

The present Application for Patent claims priority to U.S. Provisional Application No. 61/868,920 entitled “METHOD AND APPARATUS FOR DECODING MIB AND SIB DURING AUTONOMOUS SEARCH FUNCTION” filed Aug. 22, 2013, and assigned to the assignee hereof and hereby expressly incorporated by reference herein.

### BACKGROUND

Aspects of the present disclosure relate generally to wireless communications and, more particularly, to methods and apparatus for improved cell re-selection with autonomous search function (ASF).

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology.

As the demand for mobile broadband access continues to increase, research and development continue to advance the UMTS technologies not only to meet the growing demand for mobile broadband access, but to advance and enhance the user experience with mobile communications.

For example, when a user equipment (UE), which is associated with a closed subscriber group (CSG) is registered on a cell that is not associated with the CSG (e.g., a non-CSG macro cell), the UE may use an Autonomous Search Function (ASF) to detect and re-select to a potential cell that is associated with the CSG, for example, a CSG small cell which may be, in one non-limiting example, a CSG femto cell. The UE may read a Master Information Block (MIB) and a System Information Block (SIB), both of which are provided by the network, in order to determine if a particular cell is a CSG cell and calculate a re-selection ranking for the particular cell.

One approach for ASF is for a UE to read or decode the MIB and SIB for all detected cells and, subsequently, perform re-selection ranking for the detected cells. However, MIB and SIB decoding consumes large amounts of power (e.g., is a main source of awake current), especially if the number of detected cells is large. As such, improvements in cell re-selection may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, a method is described for identifying candidate cells on at least one frequency, where each of the candidate cells is associated with a cell quality, storing information related to each of the candidate cells in a candidate list, sorting the candidate list, and decoding a master information block (MIB) and one or more system information blocks (SIBs) for a subset of the candidate cells based on the sorting.

In another aspect, a computer program product for cell re-selection is provided that includes a computer readable medium including code for causing at least one computer to identify candidate cells on at least one frequency, where each of the candidate cells is associated with a cell quality, store information related to each of the candidate cells in a candidate list, sort the candidate list, decode a MIB and one or more SIBs for a subset of the candidate cells based on the sorting.

In a further aspect, an apparatus for cell re-selection is provided that includes a processing system configured to identify candidate cells on at least one frequency, where each of the candidate cells is associated with a cell quality, store information related to each of the candidate cells in a candidate list, sort the candidate list, and decode a MIB and one or more SIBs for a subset of the candidate cells based on the sorting.

These and other aspects will become more fully understood upon a review of the detailed description, which follows.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating a wireless communication system for improved cell re-selection;

FIG. 2 is a flow chart of an aspect of a method of the system of FIG. 1;

FIG. 3 is a diagram illustrating an example of a hardware implementation for an apparatus of FIG. 1 employing a processing system;

FIG. 4 is a diagram illustrating an example of a telecommunications system including aspects of the system of FIG. 1;

FIG. 5 is a diagram illustrating an example of an access network including aspects of the system of FIG. 1;

FIG. 6 is a diagram illustrating an example of a radio protocol architecture for user and control planes in aspects of the system of FIG. 1; and

FIG. 7 is a diagram illustrating an example of a Node B in communication with a UE in a telecommunications system, including aspects of the system of FIG. 1.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Some present aspects describe a new behavior for a user equipment (UE) to read Master Information Block (MIB) and System Information Block (SIB) information, which is provided by a network, as part of an Autonomous Search Function (ASF) processing at the UE. More particularly, some present aspects include identifying candidate cells to which the UE may re-select, and sorting/prioritizing the candidate cells based on re-selection criteria (e.g., re-selection ranking) prior to decoding or reading the MIB and one or more SIBs for the candidate cells. In this way, and in an aspect, the UE may read the MIB and one or more SIBs for fewer than all possible candidate cells, resulting in power savings at the UE and shorter re-selection time.

For example, a UE may belong to a closed subscriber group (CSG). A CSG is a limited set of UEs having connectivity access to a cell having a small cell coverage area, such as, for example, a femto cell. When such a small cell is configured in CSG mode, only those UEs included in an access control list of the small cell may use the small cell resources, e.g., gain wireless service from the small cell. When such a UE is registered on a cell that is not associated with the CSG (e.g., a non-CSG macro cell), the UE may use ASF to detect and re-select to a potential cell that is associated with the CSG (e.g., a CSG small cell).

Once potential cells are detected, the UE may sort and rank the detected potential cells and then, based on the sorting and ranking, decode the MIB and one or more SIBs for only a subset of the potential cells. In other words, the UE may only decode the MIB and one or more SIBs for potential cells that are the most likely re-selection candidates. Based on decoding (or reading) the MIB and one or more SIBs for the subset of the potential cells, the UE may determine if a potential cell is actually a CSG cell and, if so, re-select to that cell. If the potential cell is not a CSG cell, the UE may decode (or read) the MIB and one or more SIBs for another potential cell that is the next-most likely re-selection candidate, and so on.

In one aspect, a UE may read MIB and one or more SIBs as part of ASF processing in a single radio access technology (RAT) (e.g., W-CDMA, LTE, GSM, or Evolution Data-Only (EVDO)) scenario. In other words, a UE may seek to re-select to a cell that is associated with the same RAT as the current serving cell for the UE. In one example intra-RAT ASF procedure according to the present aspects, the UE may perform intra-frequency ASF, perform inter-frequency ASF, sort the cells in the re-selection candidate list (which includes the serving cell), decode MIB and SIB based on the sorting, and repeat these actions until a re-selection is performed or the re-selection candidate list is exhausted. Further details of each of these actions are described in what follows.

In one example intra-RAT ASF procedure, the UE may first perform intra-frequency ASF to detect candidate cells. For the serving cell, the UE skips MIB/SIB decoding. For the other cells, the UE skips MIB/SIB decoding and adds the cells to a re-selection candidate list. Also, for these cells, the UE uses a network-configured value for Qoffset,n if the cells are in a neighbor cell list (NCL), and otherwise assumes Qoffset,n=0.

Further, the UE may perform inter-frequency ASF. For the strongest cell on each frequency, the UE skips MIB/SIB decoding, adds the cell to the re-selection candidate list, and assumes Qoffset,n=0.

Then, the UE sorts the cells in the re-selection candidate list (which includes the serving cell). For the highest-ranked cell in the re-selection candidate list, the UE decodes MIB/SIB if the highest-ranked cell is not the serving cell, and then, based on the MIB/SIB, the UE determines whether the highest-ranked cell is a suitable CSG cell. If the highest-ranked cell is a suitable CSG cell, the UE re-selects to that cell and the cell re-selection process is terminated. Otherwise, the highest-ranked cell is removed from the re-selection candidate list. Upon removing the highest-ranked cell from the re-selection candidate list, the UE determines if the removed non-CSG cell is on the same frequency as the frequency of the current serving cell, and if so, the UE re-calculates cell-ranking criterion R assuming a positive Qoffset value for this intra-frequency non-CSG cell. In a non-limiting example, this positive Qoffset value may be a maximum of the Qoffset values for all cells within the NCL (e.g., Qoffset=MAX{all NCL Qoffset,n}). If the new value of R is greater than the value of R for the remaining intra-frequency cells, the UE removes the intra-frequency cells ranked below the newly calculated criterion R from the re-selection candidate list. If the removed non-CSG cell is not on the same frequency as the frequency of the current serving cell, the UE move on to evaluate the next highest ranked cell, and repeats the actions until the re-selection candidate list is exhausted or a cell re-selection is performed. Accordingly, the number of MIB and SIB decoding operations at the UE may be significantly reduced while also reducing the amount of time it takes for the UE to acquire service from a new cell.

According to 3rd Generation Partnership Project (3GPP) Technical Specification TS 25.331, section 8.1.1.5, SIB decoding for a serving cell may be performed very infrequently (e.g., every six hours) according to the general SIB expiration time described in the specification. More particularly, TS 25.331, section 8.1.1.5, states “the UE may consider the content of the scheduling block as valid until it receives the same type of scheduling block in a position according to its scheduling information or at most for 6 hours after reception.” As such, MIB/SIB decoding may be skipped for the serving cell as described above.

In one aspect, a UE may decode the MIB and SIB as part of the ASF processing where the UE is configured to operate according to more than one RAT (e.g., any combination of W-CDMA, LTE, GSM, and EVDO). For example, a UE may seek to re-select to a cell that is associated with a RAT that is different from the RAT associated with the current serving cell for the UE. In one example inter-RAT ASF procedure according to the present aspects, for each LTE frequency, the UE performs a full search, saves the strongest cell into a MIB/SIB decoding list, and continues until all frequencies have been searched. Then, the UE sorts all LTE cells in the MIB/SIB decoding list based on cell quality, for example, based on Reference Signal Received Power (RSRP). Upon sorting the cells, the UE decodes the highest-ranked cell's MIB/SIB and determines if the highest-ranked cell is a suitable CSG cell based on the MIB/SIB. If the highest-ranked cell is a suitable CSG cell, the UE uses this cell as the LTE candidate cell. Otherwise, the UE moves on to the next cell and repeats the above actions until an LTE candidate cell is found or the MIB/SIB decoding list is exhausted. Accordingly, the number of MIB and SIB decoding operations at a UE may be significantly reduced while also reducing the amount of time it takes for the UE to acquire service from a new cell.

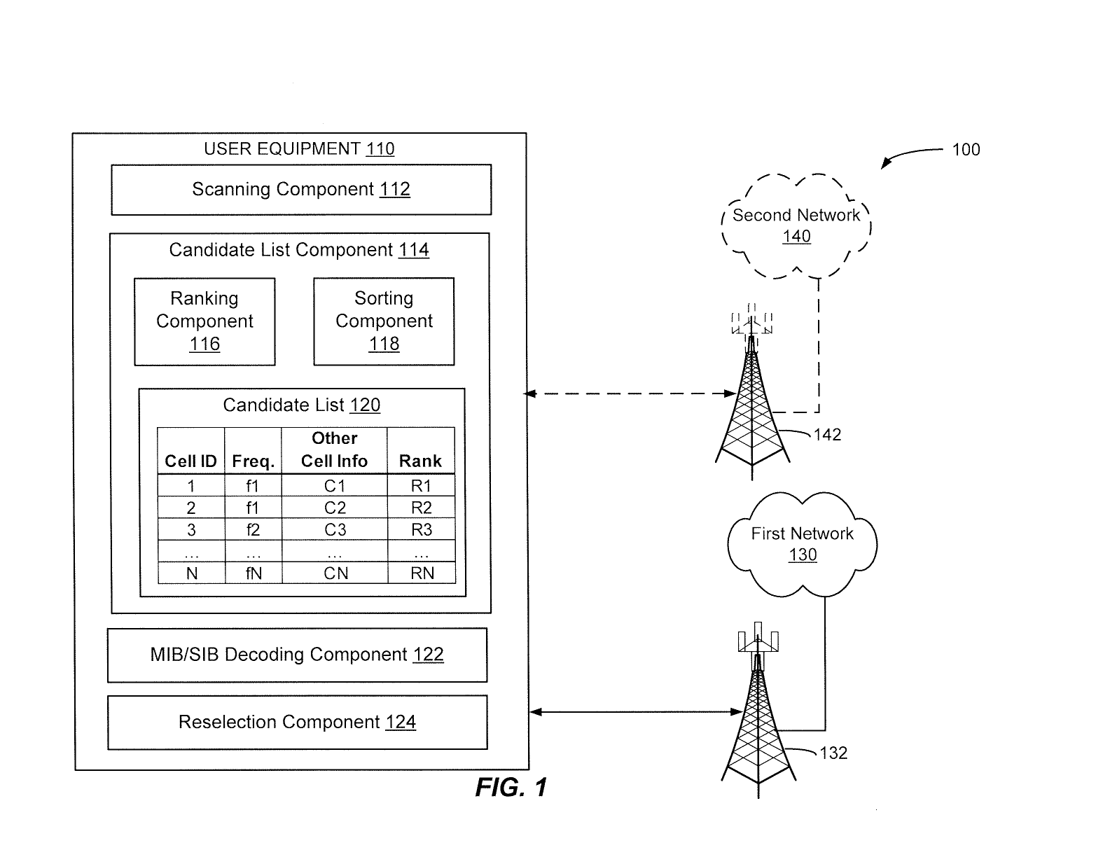

Referring to FIG. 1, a wireless communication system 100 includes a user equipment (UE) 110 in communication with a first network 130 associated with a first radio access technology (RAT) via base station 132 and optionally in communication with a second network 140 associated with a second RAT that is different from the first RAT, via base station 142.

In some aspects, UE 110 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In some aspects, base stations 132 and 142 may be a macrocell, small cell, picocell, femtocell, relay, Node B, mobile Node B, UE (e.g., communicating in peer-to-peer or ad-hoc mode with UE 110), or substantially any type of component that can communicate with UE 110 to provide access to wireless networks 130 and/or 140 at the UE 110.

In one aspect, UE 110 may be configured to perform cell re-selection through an autonomous search function (ASF). For example, UE 110 may be configured to re-select from a current serving cell (not shown) to a cell, such as base station 132, associated with a RAT that is the same as the current serving cell. This may be referred to as an intra-RAT ASF scenario. In another aspect. UE 110 may be configured to re-select to a cell, such as base station 142, which is associated with a RAT that is different from the current serving cell. This may be referred to as an inter-RAT ASF scenario. A RAT may be any radio access technology including, for example, W-CDMA, LTE, GSM, and EVDO.

UE 110 includes scanning component 112 configured to identify candidate cells on at least one frequency. UE 110 may include candidate list component 114 configured, generally, to store information related to each of the candidate cells detected by scanning component 112 in a candidate list 120, and sort the candidate list 120. The candidate list 120 may be stored in a data store (e.g., a memory) and include, for each candidate cell, a cell ID, a frequency on which the candidate cell was detected, other cell information (e.g., a primary scrambling code (PSC) in W-CDMA, a physical-layer cell identity (PCI) in LTE, and/or the like in other RATs), and a ranking (also referred to as a re-selection ranking, a re-selection criteria, or a re-selection ranking criteria and may be represented as R or R(n) for a candidate cell n). UE 110 may include MIB/SIB decoding component 122 configured to decode a master information block (MIB) and one or more system information blocks (SIBs) for a subset of the candidate cells stored in the candidate list 120 based on the sorting. More particularly, candidate list 120 may be sorted based on particular criteria, such as, in a non-limiting example, a ranking of the candidate cells. Based on the sorting, MIB/SIB decoding component 122 may be configured to decode the MIB and SIBs for one or more of the highest-ranked cells in candidate list 120.

In one aspect, UE 110 may perform ASF in an intra-RAT scenario. In other words, UE 110 may determine to re-select to a cell that is associated with the same RAT as a current, serving cell. The serving cell (not shown) also may be associated with a particular frequency and have a particular cell quality.

In some aspect, scanning component 112 of UE 110 may be configured to determine the frequency of a serving cell (not shown) for UE 110, which may be referred to as a first frequency. Scanning component 112 may be configured to scan the first frequency to detect one or more candidate cells. It is likely that scanning component 112 may detect the current serving cell for UE 110 in this first scan. In this case, scanning component 112 may be configured to essentially ignore the detected serving cell since UE 110 is already aware of the information included in the MIB and/or SIBs for the serving cell and, because the UE 110 is attempting to re-select from the serving cell, there is no need for any additional steps to be taken with respect to this cell.

For each of the cells detected by scanning component 112 during the first frequency scan, which may be referred to as candidate cells, scanning component 112 may determine information related thereto. Because the candidate cells identified during the first frequency scan are on the same frequency as the serving cell (e.g., the first frequency is the serving cell frequency), the scanning component 112 also may be configured to read a neighbor cell list (NCL) provided for the serving cell by the network to identify information related to the candidate cells, such as, for example, other cell information (e.g., PSC, PCI, and/or the like), and Qoffset. Qoffset is a value that describes a difference between cell quality of a detected candidate cell and cell quality of the serving cell. For candidate cells in the NCL, the Qoffset value may be read based on network-provided information. In the non-limiting example of W-CDMA, the Qoffset may be read from SIB 11 (SIB11). In some instances, however, detected candidate cells on the first frequency may not be included in the NCL. In that case, scanning component 112 may be configured to assume a Qoffset value, such as, in a non-limiting example, a Qoffset value of zero, for those non-NCL candidate cells.

Once all candidate cells on the first frequency are detected, scanning component 112 may be configured to scan additional frequencies, which are different from the first frequency associated with the serving cell, to detect additional candidate cells. Any candidate cells detected by scanning the first frequency will not necessarily be part of the NCL and, as such, scanning component 112 may be configured to determine information related to those candidate cells based on measurements and/or the like. For example, with respect to a Qoffset value for each of the candidate cells, scanning component 112 may be configured to assume a particular Qoffset value, such as, in a non-limiting example, a Qoffset value of zero. Scanning component 112 may be configured to provide the candidate cells (e.g., as identified by a cell ID) and related information (e.g., other cell information, Qoffset) to candidate list component 114 for storing in the candidate list 120.

Candidate list component 114 includes ranking component 116 configured to calculate a ranking for the candidate cells stored in candidate list 120. The ranking of non-serving cells may be determined based on the formula R(n)=Qmeas,n−Qoffset,n, where R(n) is the ranking of a particular candidate cell n, Qmeas,n is a measured cell quality for a particular candidate cell n (e.g., Ec/Io or RSCP), and Qoffset, n is a value that describes a difference in cell quality between the particular candidate cell n and the serving cell. The ranking of the current serving cell may be determined based on the formula R(s)=Qmeas,s−Qhyst, where R(s) is the ranking of the serving cell s, Qmeas,s is a measured cell quality for the serving cell s (e.g., Ec/Io or RSCP), and Qhyst is the hysteresis value in the cell ranking criteria for the serving cell. Candidate list component 114 may calculate a ranking for each of the candidate cells as an entry for the candidate cell is stored within candidate list 120, at predetermined times, when candidate list 120 is updated and/or the like.

Candidate list component 114 also includes sorting component 118 configured to sort the candidate list based on the ranking of each of the candidate cells. In an aspect, however, sorting component 118 may be configured to sort the candidate cells in candidate list 120 based on some other criteria in addition to, or instead of, the ranking.

UE 110 includes MIB/SIB decoding component 122 configured to decode a MIB and one or more SIBs for a subset of the candidate cells included in candidate list 120. In an aspect, candidate list component 114 may be configured to communicate to MIB/SIB decoding component 122 that sorting of candidate list 120 has been completed. In an aspect, candidate list component 114 also may be configured to provide the highest-ranked candidate cell to MIB/SIB decoding component 122 upon completion of the sorting of candidate list 120.

MIB/SIB decoding component 122 may be configured to decode the MIB and one or more SIBs for the highest-ranked candidate cell. Based on the decoding, MIB/SIB decoding component 122 may be configured to determine if the highest-ranked candidate cell is, in fact, a CSG cell. If so, MIB/SIB decoding component 122 may be configured to provide an indication of the highest-ranked CSG candidate cell to re-selection component 124. In response, re-selection component 124 may be configured to re-select from the serving cell to the highest-ranked CSG candidate cell.

If MIB/SIB decoding component 122 determines that the highest-ranked candidate cell is not a CSG cell, MIB/SIB decoding component 122 may be configured to instruct candidate list component 114 to remove the highest-ranked candidate cell, which may be referred to as a rejected cell, from the candidate list 120. In addition, MIB/SIB decoding component 122 may be configured to determine whether the rejected cell was detected based on scanning the first (e.g., serving cell) frequency or another frequency. If the rejected cell was detected based on scanning the first frequency (e.g., the rejected cell and the serving cell are on the same frequency), MIB/SIB decoding component 122 may be configured to instruct candidate list component 114 to recalculate the ranking for the rejected cell. In response, ranking component 116 may be configured to select a different Qoffset value for the rejected cell based on a function. In a non-limiting example, the function may be a maximum of the Qoffset values for all cells within the NCL (e.g., Qoffset=MAX{all NCL Qoffset,n}).

The ranking component 116 may be configured to re-calculate the ranking for the rejected cell based on the newly confirmed Qoffset value and compare the updated ranking with the rankings of all of the other candidate cells stored in candidate list 120 that were detected during a scan of the first frequency. If any of the other candidate cells have a ranking that is lower than the recalculated ranking for the rejected cell, ranking component 116 may be configured to remove those other candidate cells from candidate list 120. Upon completion of such processing, candidate list component 114 may be configured to communicate an indication of same to MIB/SIB decoding component 122 and, in an aspect, provide a next-highest-ranked candidate cell to MIB/SIB decoding component 122. MIB/SIB decoding component 122 may be configured to repeat the processes described herein for the next-highest-ranked candidate cell until a CSG candidate cell is found.

In another aspect, UE 110 may perform ASF processing in an inter-RAT scenario. In other words, UE 110 may determine to re-select to a cell that is associated with a RAT that is different from the RAT of a current, serving cell (not shown) for UE 110.

In the aspect, scanning component 112 may be configured to determine a target RAT, which is different from the serving cell RAT. In one non-limiting example, the target RAT may be LTE, while the serving cell RAT may be W-CDMA. Other examples may include any combination of serving cell RAT and target RAT, including LTE, W-CDMA, GSM, and EVDO.

Scanning component 112 may be configured to scan each frequency associated with the target RAT to detect a strongest candidate cell on each frequency. Scanning component 112 also may be configured to determine information associated with each of the strongest candidate cells, including other cell information and cell quality (e.g., pilot channel power to total power (Ec/lo), RSRP, and/or the like). Scanning component 112 may be configured to provide the strongest candidate cells (e.g., using an identifier such as cell ID) and related information to candidate list component 114 for storing in candidate list 120.

In the aspect, sorting component 118 may be determined to sort the strongest candidate cells stored in candidate list 120 based on the cell quality information determined by scanning component 112. In the aspect, ranking component 116 may be configured to determine a ranking for each of the strongest candidate cells as a result of the sorting. In one example, the strongest candidate cell with the highest cell quality may be given a highest ranking, the strongest candidate cell with the next-highest cell quality may be given a next-highest ranking, and so on.

Candidate list component 114 may be configured to communicate with MIB/SIB decoding component 122 to indicate that the sorting and ranking of the strongest candidate cells in candidate list 120 has been completed and, in an aspect, provide the highest-ranked strongest candidate cell to MIB/SIB decoding component 122.

MIB/SIB decoding component 122 may be configured to decode the MIB and one or more SIBs for the highest-ranked strongest candidate cell. Based on the decoding, MIB/SIB decoding component 122 may be configured to determine if the highest-ranked strongest candidate cell is a CSG cell. If so, MIB/SIB decoding component 122 may be configured to provide an indication of the highest-ranked CSG strongest candidate cell to re-selection component 124. In response, re-selection component 124 may be configured to re-select from the serving cell to the highest-ranked CSG strongest candidate cell.

If MIB/SIB decoding component 122 determines that the highest-ranked strongest candidate cell is not a CSG cell, MIB/SIB decoding component 122 may be configured to so inform candidate list component 114. In response, candidate list component 114 may be configured to provide the next-highest-ranked strongest candidate cell to MIB/SIB decoding component 122. MIB/SIB decoding component 122 may decode the MIB and one or more SIBs for the next-highest-ranked strongest candidate cell and determine if it is a CSG cell. MIB/SIB decoding component 122 may be configured to continue to decode MIB and one or more SIBs for strongest candidate cells until a suitable CSG strongest candidate cell is identified and UE 110 re-selects thereto or all of the strongest candidate cells in candidate list 120 are exhausted.

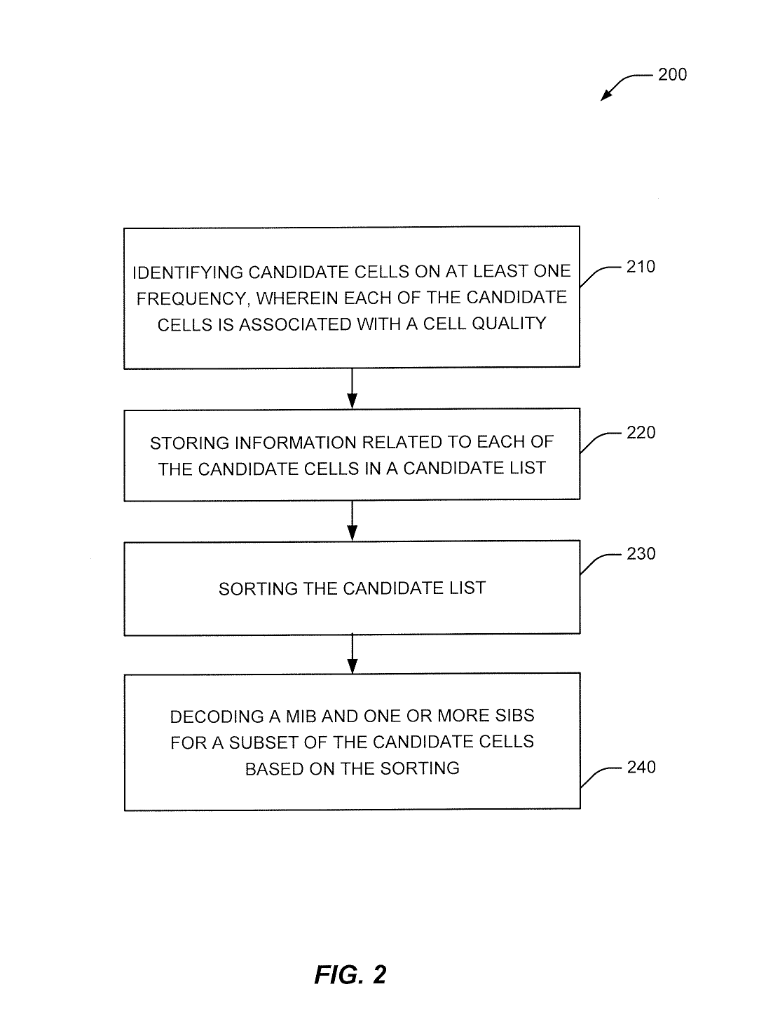

Referring to FIG. 2, an example method 200 for cell re-selection according to some present aspects may be performed by UE 110. More particularly, aspects of method 200 may be performed by scanning component 112, candidate list component 114 (including ranking component 116 and sorting component 118 in communication with one another and candidate list 120), and/or MIB/SIB decoding component 122.

At 210, the method 200 includes identifying candidate cells on at least one frequency, where each of the candidate cells is associated with a cell quality. For example, scanning component 112 may be configured to identify candidate cells on at least one frequency and determine a cell quality and other information (e.g., other cell information. Qoffset value) for the candidate cells. In some aspects, scanning component 112 may be configured to identify candidate cells by determining a first frequency associated with a serving cell, scanning the first frequency to detect one or more candidate cells, and scanning one or more other frequencies to detect additional candidate cells, where each of the additional candidate cells is a strongest cell in a corresponding frequency. In some aspects, scanning component 112 may alternatively or additionally be configured to identify candidate cells by determining a target RAT that is different from a RAT of a serving cell and scanning each frequency associated with the target RAT to detect a strongest candidate cell on each frequency.

At 220, the method 200 includes storing information related to each of the candidate cells in a candidate list. For example, candidate list component 114 may be configured to store information (e.g., cell ID, other cell information, Qoffset value, and rank) related to each of the candidate cells in candidate list 120. In some aspects, candidate list component 114 may be configured to determine whether each of the candidate cells is included in the NCL and determine a Qoffset value for each of the candidate cells accordingly, where the Qoffset value is an indication of the cell quality of a candidate cell as compared with a serving cell. In these aspects, candidate list component 114 may be further configured to calculate a ranking for each of the candidate cells based on a corresponding Qoffset value. In some aspects, the information stored by candidate list component 114 related to each of the candidate cells may include the ranking for each of the candidate cells, a frequency on which each of the candidate cells were detected, and other cell information for each of the candidate cells. In some aspects, candidate list component 114 may be configured to determine that a candidate cell is included in the NCL and read network-provided information to determine the Qoffset value for the candidate cell, or otherwise determine that a candidate cell is not included in the NCL and assume a value of zero for the Qoffset values. In some aspects where candidate cells are identified by detecting a strongest candidate cell on each frequency associated with a target RAT that is different from a RAT of a serving cell, candidate list component 114 may alternatively or additionally store information related to strongest candidate cells detected on each frequency.

At 230, the method 200 includes sorting the candidate list. For example, sorting component 118 may be configured to sort candidate list 120 based on, in one aspect, a ranking of each of the candidate cells determined by ranking component 116. In some aspects where candidate cells are identified by detecting a strongest candidate cell on each frequency associated with a target RAT that is different from a RAT of a serving cell, sorting component 118 may be alternatively or additionally configured to sort the strongest candidate cells based on the cell quality of each of the strongest candidate cells and determine a ranking for each of the strongest candidate cells based on the results of the sorting. In these aspects, the information related to the strongest candidate cells stored by candidate list component 114 may include the ranking determined by sorting component 118 for each of the strongest candidate cells, a frequency on which each of the strongest candidate cells were detected by scanning component 112, and other cell information for each of the strongest candidate cells.

At 240, the method 200 includes decoding a MIB and one or more SIBs for a subset of the candidate cells based on the sorting. For example, MIB/SIB decoding component 122 may be configured to decode a MIB and one or more SIBs for a subset of the candidate cells, such as, for example, the highest-ranked candidate cells, based on the sorting performed by sorting component 118. For example, MIB/SIB decoding component 122 may be configured to determine a highest-ranked cell in the candidate list based on the sorting performed by sorting component 118 and decode the MIB and the one or more SIBs for the highest-ranked cell. Further, in some aspects, MIB/SIB decoding component 122 may be configured to determine that the highest-ranked cell is a CSG cell and re-select to the highest-ranked cell, or otherwise determine that the highest-ranked cell is not a CSG cell. In these aspects, when MIB/SIB decoding component 122 determine that the highest-ranked cell is not a CSG cell, MIB/SIB decoding component 122 may remove the highest-ranked cell from the candidate list. Then, if MIB/SIB decoding component 122 determines that the highest-ranked cell was detected based on scanning a first frequency of the serving cell, MIB/SIB decoding component 122 may determine an actual Qoffset value for the highest-ranked cell and re-calculate the ranking of the highest-ranked cell based on the actual Qoffset value. Further, if MIB/SIB decoding component 122 determines that the re-calculated ranking of the highest-ranked cell is greater than the ranking of a set of candidate cells that are on the same frequency as the highest-ranked cell, MIB/SIB decoding component 122 removes such set of candidate cells from the candidate list and decodes the MIB and the one or more SIBs for the next highest-ranked cell.

In some aspects where candidate cells are identified by detecting a strongest candidate cell on each frequency associated with a target RAT that is different from a RAT of a serving cell, MIB/SIB decoding component 122 may be alternatively or additionally configured to determine a highest-ranked strongest candidate cell in the candidate list and decode the MIB and the one or more SIBs for the highest-ranked strongest candidate cell. In these aspects, if MIB/SIB decoding component 122 determines that the highest-ranked strongest candidate cell is a CSG cell, MIB/SIB decoding component 122 may re-select to the highest-ranked strongest candidate cell. Otherwise, if MIB/SIB decoding component 122 determines that the highest-ranked strongest candidate cell is not a CSG cell, MIB/SIB decoding component 122 may decode the MIB and the one or more SIBs for a next highest-ranked strongest candidate cell.

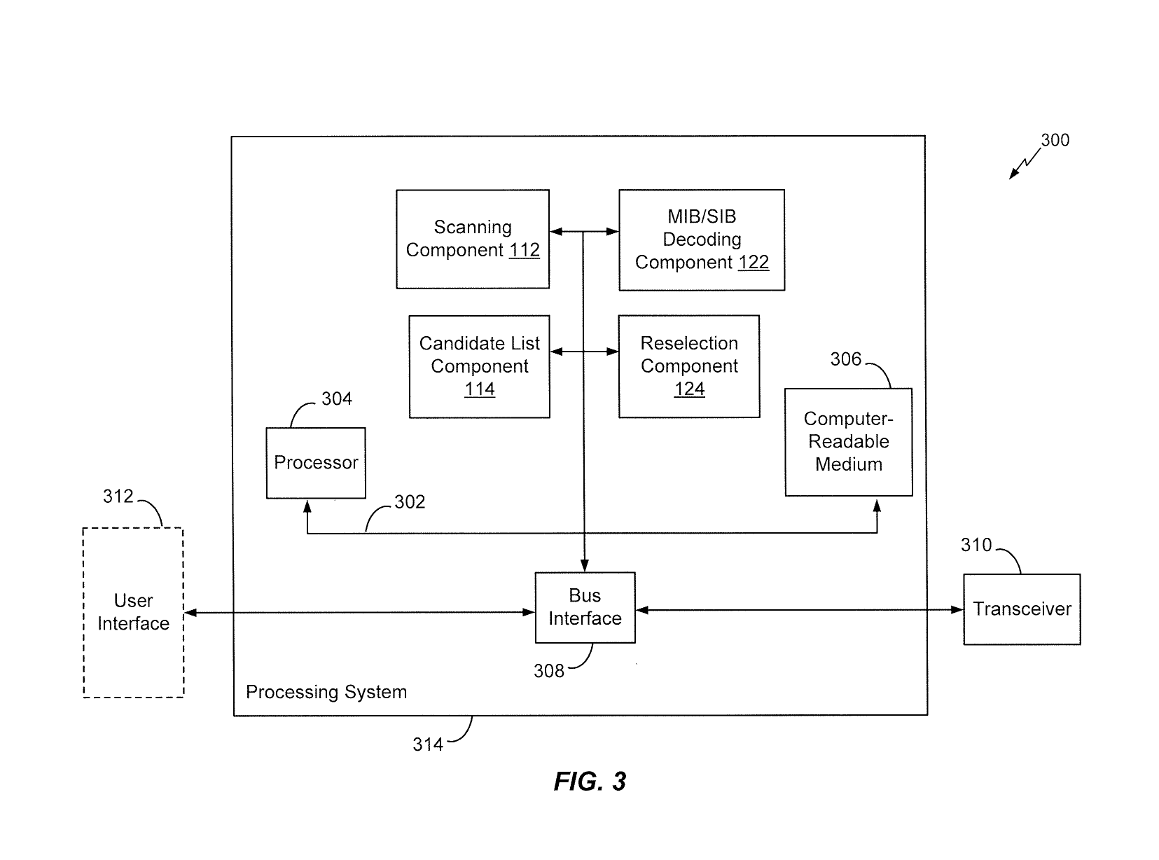

FIG. 3 is a block diagram illustrating an example of a hardware implementation for an apparatus 300 employing a processing system 314 to operate UE 110, scanning component 112, candidate list component 114, MIB/SIB decoding component 122, re-selection component 124, and/or respective components thereof (see FIG. 1). In this example, the processing system 314 may be implemented with a bus architecture, represented generally by the bus 302. The bus 302 may include any number of interconnecting buses and bridges depending on the specific application of the processing system 314 and the overall design constraints. The bus 302 links together various circuits including one or more processors, represented generally by the processor 304, computer-readable media, represented generally by the computer-readable medium 306, and scanning component 112, candidate list component 114, MIB/SIB decoding component 122 and re-selection component 124, all of FIG. 1. The bus 302 may also link various other circuits such as timing sources, peripherals, voltage regulators, and power management circuits, which are well known in the art, and therefore, will not be described any further. A bus interface 308 provides an interface between the bus 302 and a transceiver 310. The transceiver 310 provides a means for communicating with various other apparatus over a transmission medium. Depending upon the nature of the apparatus, a user interface 312 (e.g., keypad, display, speaker, microphone, joystick) may also be provided.

The processor 304 is responsible for managing the bus 302 and general processing, including the execution of software stored on the computer-readable medium 306. The software, when executed by the processor 304, causes the processing system 314 to perform the various functions described herein related to adaptive receive diversity for any particular apparatus. The computer-readable medium 306 may also be used for storing data that is manipulated by the processor 304 when executing software. The processor 304 and the computer-readable medium 306 may be configured to perform some or all of the functions/features described herein for UE 110, scanning component 112, candidate list component 114, MIB/SIB decoding component 122, re-selection component 124, and/or respective components thereof (see FIG. 1).

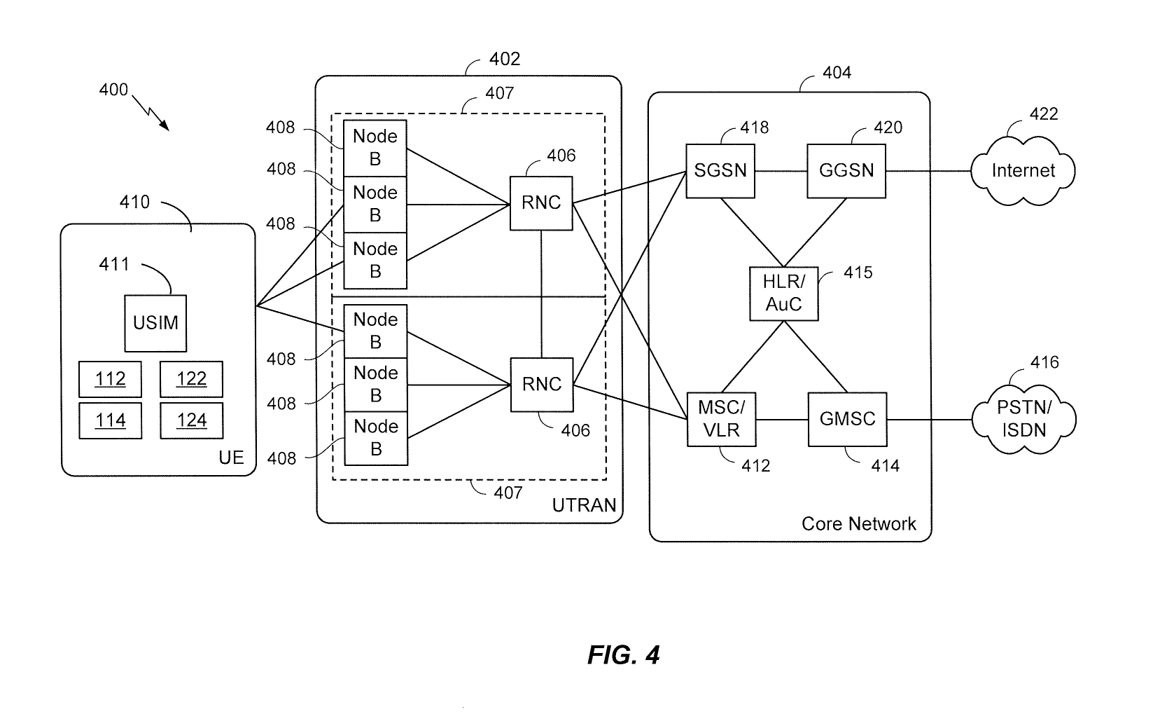

The various concepts presented throughout this disclosure may be implemented across a broad variety of telecommunication systems, network architectures, and communication standards. By way of example and without limitation, the aspects of the present disclosure illustrated in FIG. 4 are presented with reference to a UMTS system 400, having aspects configured for adaptive receive diversity as described herein, employing a W-CDMA air interface. A UMTS network includes three interacting domains: a Core Network (CN) 404, a UMTS Terrestrial Radio Access Network (UTRAN) 402, and User Equipment (UE) 410, which may be UE 110 of FIG. 1 and/or may include scanning component 112, candidate list component 114, MIB/SIB decoding component 122, and/or re-selection component 124. In this example, the UTRAN 402 provides various wireless services including telephony, video, data, messaging, broadcasts, and/or other services. The UTRAN 402 may include a plurality of Radio Network Subsystems (RNSs) such as an RNS 407, each controlled by a respective Radio Network Controller (RNC) such as an RNC 406. Here, the UTRAN 402 may include any number of RNCs 406 and RNSs 407 in addition to the RNCs 406 and RNSs 407 illustrated herein. The RNC 406 is an apparatus responsible for, among other things, assigning, reconfiguring and releasing radio resources within the RNS 407. The RNC 406 may be interconnected to other RNCs (not shown) in the UTRAN 402 through various types of interfaces such as a direct physical connection, a virtual network, or the like, using any suitable transport network.

Communication between a UE 410 and a Node B 408, which may be base station 132 and/or base station 142 of FIG. 1, may be considered as including a physical (PHY) layer and a medium access control (MAC) layer. Further, communication between a UE 410 and an RNC 406 by way of a respective Node B 408 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0.

The geographic region covered by the RNS 407 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 408 are shown in each RNS 407; however, the RNSs 407 may include any number of wireless Node Bs. The Node Bs 408 provide wireless access points to a CN 404 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 410 may further include a universal subscriber identity module (USIM) 411, which contains a user's subscription information to a network. For illustrative purposes, one UE 410 is shown in communication with a number of the Node Bs 408. The DL, also called the forward link, refers to the communication link from a Node B 408 to a UE 410, and the UL, also called the reverse link, refers to the communication link from a UE 410 to a Node B 408.

The CN 404 interfaces with one or more access networks, such as the UTRAN 402. As shown, the CN 404 is a GSM core network. However, as those skilled in the art will recognize, the various concepts presented throughout this disclosure may be implemented in a RAN, or other suitable access network, to provide UEs with access to types of CNs other than GSM networks.

The CN 404 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 404 supports circuit-switched services with a MSC 412 and a GMSC 414. In some applications, the GMSC 414 may be referred to as a media gateway (MGW). One or more RNCs, such as the RNC 406, may be connected to the MSC 412. The MSC 412 is an apparatus that controls call setup, call routing, and UE mobility functions. The MSC 412 also includes a VLR that contains subscriber-related information for the duration that a UE is in the coverage area of the MSC 412. The GMSC 414 provides a gateway through the MSC 412 for the UE to access a circuit-switched network 416. The GMSC 414 includes a home location register (HLR) 415 containing subscriber data, such as the data reflecting the details of the services to which a particular user has subscribed. The HLR is also associated with an authentication center (AuC) that contains subscriber-specific authentication data. When a call is received for a particular UE, the GMSC 414 queries the HLR 415 to determine the UE's location and forwards the call to the particular MSC serving that location.

The CN 404 also supports packet-data services with a serving GPRS support node (SGSN) 418 and a gateway GPRS support node (GGSN) 420. GPRS, which stands for General Packet Radio Service, is designed to provide packet-data services at speeds higher than those available with standard circuit-switched data services. The GGSN 420 provides a connection for the UTRAN 402 to a packet-based network 422. The packet-based network 422 may be the Internet, a private data network, or some other suitable packet-based network. The primary function of the GGSN 420 is to provide the UEs 410 with packet-based network connectivity. Data packets may be transferred between the GGSN 420 and the UEs 410 through the SGSN 418, which performs primarily the same functions in the packet-based domain as the MSC 412 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 408 and a UE 410. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases. HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 410 provides feedback to the Node B 408 over the HS-DPCCH to indicate whether it correctly decoded a packet on the downlink.

HS-DPCCH further includes feedback signaling from the UE 410 to assist the Node B 408 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the Node B 408 and/or the UE 410 may have multiple antennas supporting MIMO technology. The use of MIMO technology enables the Node B 408 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 410 to increase the data rate or to multiple UEs 410 to increase the overall system capacity. This is achieved by spatially precoding each data stream and then transmitting each spatially precoded stream through a different transmit antenna on the downlink. The spatially precoded data streams arrive at the UE(s) 410 with different spatial signatures, which enables each of the UE(s) 410 to recover the one or more the data streams destined for that UE 410. On the uplink, each UE 410 may transmit one or more spatially precoded data streams, which enables the Node B 408 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

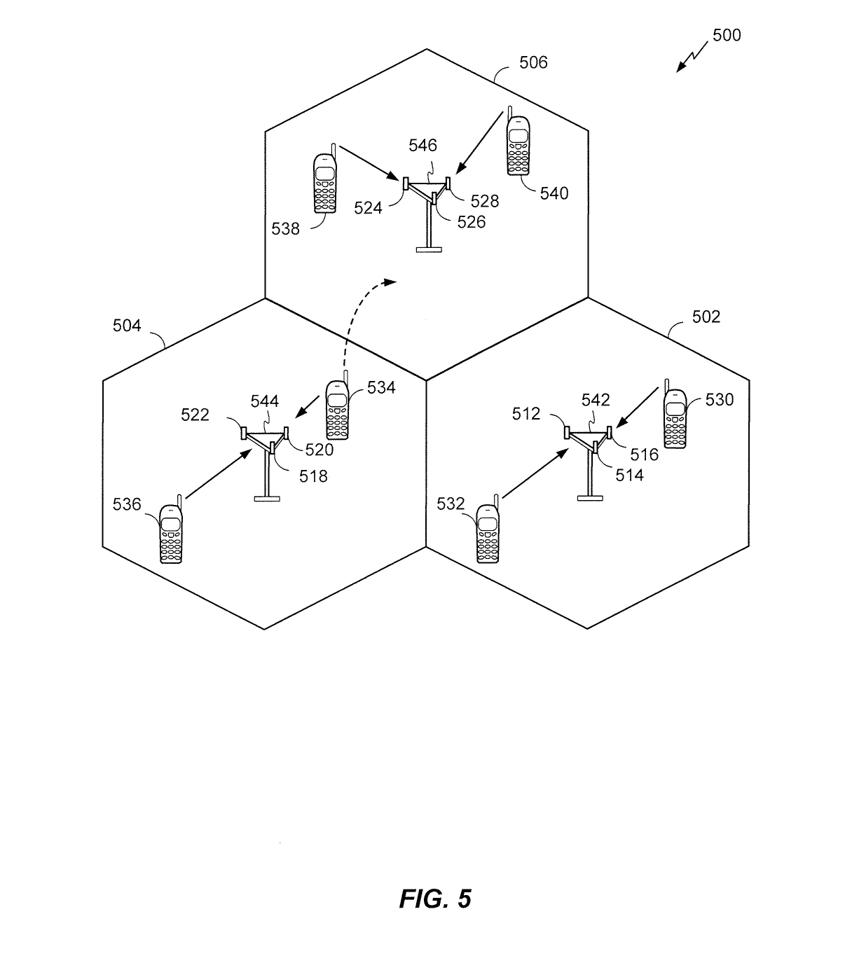

Referring to FIG. 5, an access network 500, having aspects configured to decode MIB and one or more SIBs during ASF as described herein, in a UTRAN architecture is illustrated. The multiple access wireless communication system includes multiple cellular regions (cells), including cells 502, 504, and 506, each of which may include one or more sectors. The multiple sectors can be formed by groups of antennas with each antenna responsible for communication with UEs in a portion of the cell. For example, in cell 502, antenna groups 512, 514, and 516 may each correspond to a different sector. In cell 504, antenna groups 518, 520, and 522 each correspond to a different sector. In cell 506, antenna groups 524, 526, and 528 each correspond to a different sector. The cells 502, 504 and 506 may include several wireless communication devices, e.g., User Equipment or UEs, which may be in communication with one or more sectors of each cell 502, 504 or 506. For example, UEs 530 and 532 may be in communication with Node B 542, UEs 534 and 536 may be in communication with Node B 544, and UEs 538 and 540 can be in communication with Node B 546. Here, each Node B 542, 544, 546 is configured to provide an access point to a CN 404 (see FIG. 4) for all the UEs 530, 532, 534, 536, 538, 540 in the respective cells 502, 504, and 506. In an aspect, UEs 530, 532, 534, 536, 538, and 540 may be UE 110 of FIG. 1 and Node B 542, 544, and 546 may be base station 132 and/or base station 142 of FIG. 1.

As the UE 534 moves from the illustrated location in cell 504 into cell 506, a serving cell change (SCC) or handover may occur in which communication with the UE 534 transitions from the cell 504, which may be referred to as the source cell, to cell 506, which may be referred to as the target cell. Management of the handover procedure may take place at the UE 534, at the Node Bs corresponding to the respective cells, at a radio network controller 406 (see FIG. 4), or at another suitable node in the wireless network. For example, during a call with the source cell 504, or at any other time, the UE 534 may monitor various parameters of the source cell 504 as well as various parameters of neighboring cells such as cells 506 and 502. Further, depending on the quality of these parameters, the UE 534 may maintain communication with one or more of the neighboring cells. During this time, the UE 534 may maintain an Active Set, that is, a list of cells that the UE 534 is simultaneously connected to (i.e., the UTRA cells that are currently assigning a downlink dedicated physical channel DPCH or fractional downlink dedicated physical channel F-DPCH to the UE 534 may constitute the Active Set).

The modulation and multiple access scheme employed by the access network 500 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

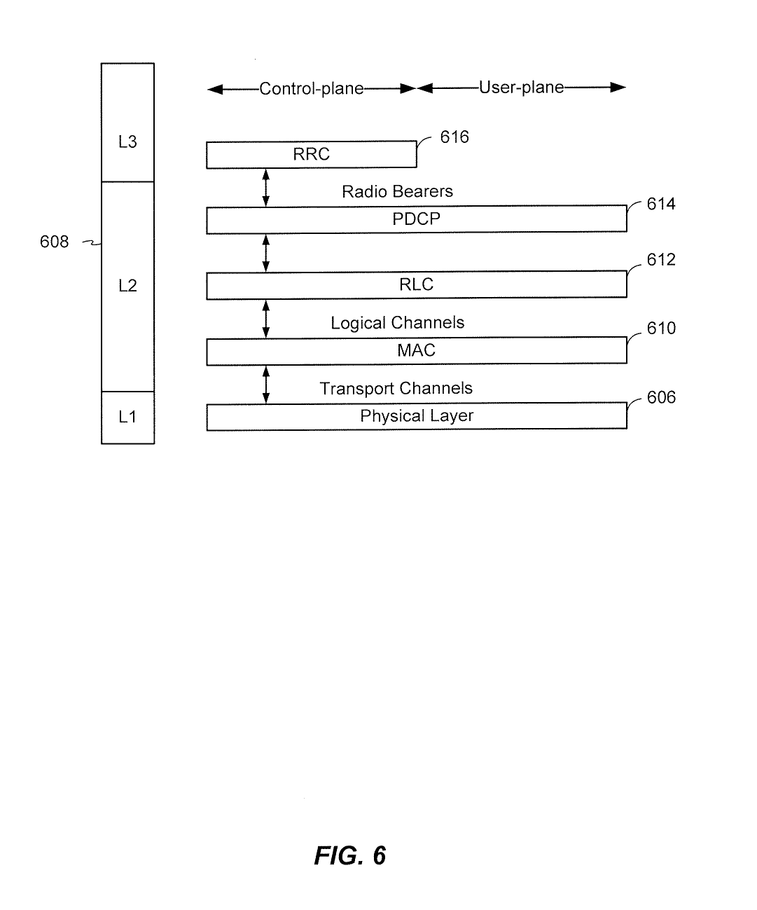

The radio protocol architecture may take on various forms depending on the particular application. An example for an HSPA system will now be presented with reference to FIG. 6.

Referring to FIG. 6 an example radio protocol architecture 600 relates to the user plane 602 and the control plane 604 of a user equipment (UE), such as UE 110 of FIG. 1, having aspects configured having aspects configured to decode MIB and one or more SIBs during UMTS as described herein, and/or Node B/base station, such as base station 132 and/or base station 142 of FIG. 1. The radio protocol architecture 600 for the UE and Node B is shown with three layers: Layer 1 606, Layer 2 608, and Layer 3 610. Layer 1 606 is the lowest lower and implements various physical layer signal processing functions. As such, Layer 1 606 includes the physical layer 607. Layer 2 (L2 layer) 608 is above the physical layer 607 and is responsible for the link between the UE and Node B over the physical layer 607. Layer 3 (L3 layer) 610 includes a radio resource control (RRC) sublayer 615. The RRC sublayer 615 handles the control plane signaling of Layer 3 between the UE and the UTRAN.

In the user plane, the L2 layer 608 includes a media access control (MAC) sublayer 609, a radio link control (RLC) sublayer 611, and a packet data convergence protocol (PDCP) 613 sublayer, which are terminated at the Node B on the network side. Although not shown, the UE may have several upper layers above the L2 layer 608 including a network layer (e.g., IP layer) that is terminated at a PDN gateway on the network side, and an application layer that is terminated at the other end of the connection (e.g., far end UE, server, etc.).

The PDCP sublayer 613 provides multiplexing between different radio bearers and logical channels. The PDCP sublayer 613 also provides header compression for upper layer data packets to reduce radio transmission overhead, security by ciphering the data packets, and handover support for UEs between Node Bs. The RLC sublayer 611 provides segmentation and reassembly of upper layer data packets, retransmission of lost data packets, and reordering of data packets to compensate for out-of-order reception due to hybrid automatic repeat request (HARQ). The MAC sublayer 609 provides multiplexing between logical and transport channels. The MAC sublayer 609 is also responsible for allocating the various radio resources (e.g., resource blocks) in one cell among the UEs. The MAC sublayer 609 is also responsible for HARQ operations.

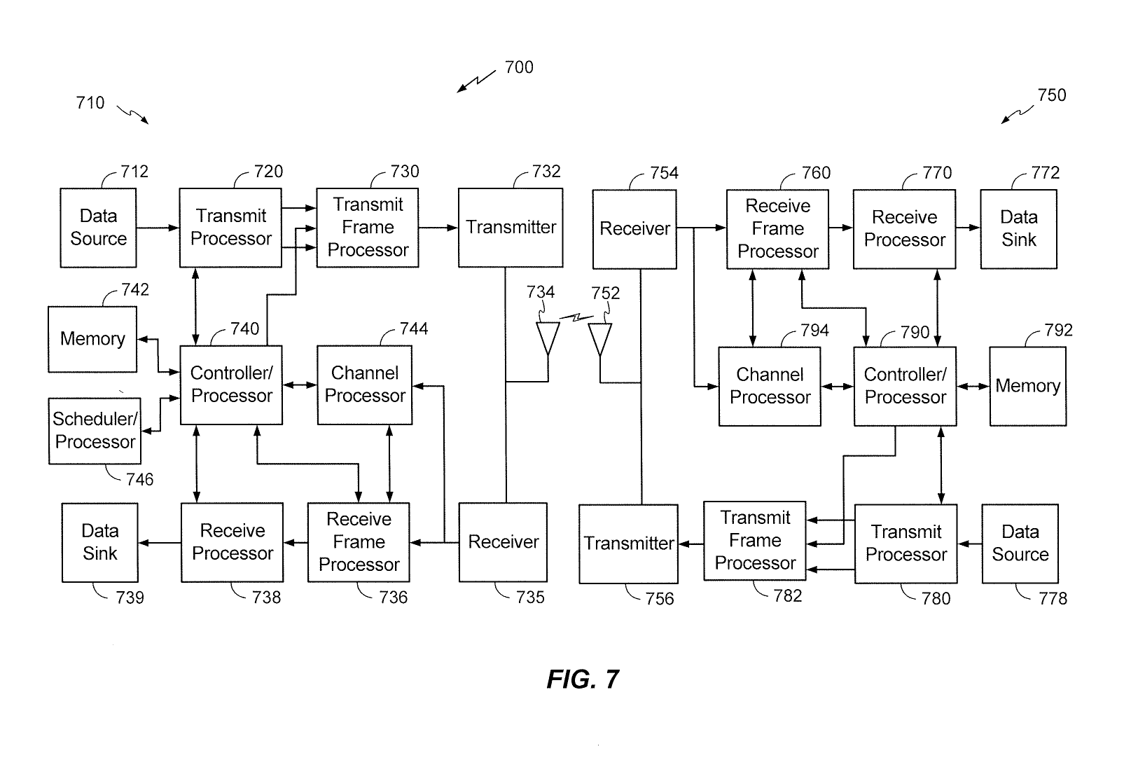

FIG. 7 is a block diagram of a Node B 710 in communication with a UE 750, where the Node B 710 may be Node B 408 of FIG. 4 and/or base station 132 and/or base station 142 of FIG. 1, and the UE 750 may be UE 410 of FIG. 4, UE 110 of FIG. 1, or apparatus 300 of FIG. 3, and may include scanning component 112 (not shown), candidate list component 114 (not shown), MIB/SIB decoding component 122 (not shown), and re-selection component 124 (not shown). UE 750 may be configured to perform some or all of the functions/features described herein for UE 110, UE 410, apparatus 300, scanning component 112, candidate list component 114, MIB/SIB decoding component 122, re-selection component 124, and/or respective components thereof (see FIGS. 1, 3, and 4). In the downlink communication, a transmit processor 720 may receive data from a data source 712 and control signals from a controller/processor 740. The transmit processor 720 provides various signal processing functions for the data and control signals, as well as reference signals (e.g., pilot signals). For example, the transmit processor 720 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 744 may be used by a controller/processor 740 to determine the coding, modulation, spreading, and/or scrambling schemes for the transmit processor 720. These channel estimates may be derived from a reference signal transmitted by the UE 750 or from feedback from the UE 750. The symbols generated by the transmit processor 720 are provided to a transmit frame processor 730 to create a frame structure. The transmit frame processor 730 creates this frame structure by multiplexing the symbols with information from the controller/processor 740, resulting in a series of frames. The frames are then provided to a transmitter 732, which provides various signal conditioning functions including amplifying, filtering, and modulating the frames onto a carrier for downlink transmission over the wireless medium through antenna 734. The antenna 734 may include one or more antennas, for example, including beam steering bidirectional adaptive antenna arrays or other similar beam technologies.

At the UE 750, a receiver 754 receives the downlink transmission through an antenna 752 and processes the transmission to recover the information modulated onto the carrier. The information recovered by the receiver 754 is provided to a receive frame processor 760, which parses each frame, and provides information from the frames to a channel processor 794 and the data, control, and reference signals to a receive processor 770. The receive processor 770 then performs the inverse of the processing performed by the transmit processor 720 in the Node B 710. More specifically, the receive processor 770 descrambles and despreads the symbols, and then determines the most likely signal constellation points transmitted by the Node B 710 based on the modulation scheme. These soft decisions may be based on channel estimates computed by the channel processor 794. The soft decisions are then decoded and deinterleaved to recover the data, control, and reference signals. The CRC codes are then checked to determine whether the frames were successfully decoded. The data carried by the successfully decoded frames will then be provided to a data sink 772, which represents applications running in the UE 750 and/or various user interfaces (e.g., display). Control signals carried by successfully decoded frames will be provided to a controller/processor 790. When frames are unsuccessfully decoded by the receiver processor 770, the controller/processor 790 may also use an acknowledgement (ACK) and/or negative acknowledgement (NACK) protocol to support retransmission requests for those frames.

In the uplink, data from a data source 778 and control signals from the controller/processor 790 are provided to a transmit processor 780. The data source 778 may represent applications running in the UE 750 and various user interfaces (e.g., keyboard). Similar to the functionality described in connection with the downlink transmission by the Node B 710, the transmit processor 780 provides various signal processing functions including CRC codes, coding and interleaving to facilitate FEC, mapping to signal constellations, spreading with OVSFs, and scrambling to produce a series of symbols. Channel estimates, derived by the channel processor 794 from a reference signal transmitted by the Node B 710 or from feedback contained in the midamble transmitted by the Node B 710, may be used to select the appropriate coding, modulation, spreading, and/or scrambling schemes. The symbols produced by the transmit processor 780 will be provided to a transmit frame processor 782 to create a frame structure. The transmit frame processor 782 creates this frame structure by multiplexing the symbols with information from the controller/processor 790, resulting in a series of frames. The frames are then provided to a transmitter 756, which provides various signal conditioning functions including amplification, filtering, and modulating the frames onto a carrier for uplink transmission over the wireless medium through the antenna 752.

The uplink transmission is processed at the Node B 710 in a manner similar to that described in connection with the receiver function at the UE 750. A receiver 735 receives the uplink transmission through the antenna 734 and processes the transmission to recover the information modulated onto the carrier. The information recovered by the receiver 735 is provided to a receive frame processor 736, which parses each frame, and provides information from the frames to the channel processor 744 and the data, control, and reference signals to a receive processor 738. The receive processor 738 performs the inverse of the processing performed by the transmit processor 780 in the UE 750. The data and control signals carried by the successfully decoded frames may then be provided to a data sink 739 and the controller/processor, respectively. If some of the frames were unsuccessfully decoded by the receive processor, the controller/processor 740 may also use an acknowledgement (ACK) and/or negative acknowledgement (NACK) protocol to support retransmission requests for those frames.

The controller/processors 740 and 790 may be used to direct the operation at the Node B 710 and the UE 750, respectively. For example, the controller/processors 740 and 790 may provide various functions including timing, peripheral interfaces, voltage regulation, power management, and other control functions. The computer readable media of memories 742 and 792 may store data and software for the Node B 710 and the UE 750, respectively. A scheduler/processor 746 at the Node B 710 may be used to allocate resources to the UEs and schedule downlink and/or uplink transmissions for the UEs. Further, the controller/processors 790 and the memory 792 may be used to perform some or all of the functions/features described herein for UE 110, UE 410, apparatus 300, scanning component 112, candidate list component 114, MIB/SIB decoding component 122, re-selection component 124, and/or respective components thereof (see FIGS. 1, 3, and 4).

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM□, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

The term “small cell,” as used herein, refers to a relative low transmit power and/or a relatively small coverage area cell as compared to a transmit power and/or a coverage area of a macro cell. Further, the term “small cell” may include, but is not limited to, cells such as a femto cell, a pico cell, access point base stations, Home NodeBs, femto access points, or femto cells. For instance, a macro cell may cover a relatively large geographic area, such as, but not limited to, several kilometers in radius. In contrast, a pico cell may cover a relatively small geographic area, such as, but not limited to, a building. Further, a femto cell also may cover a relatively small geographic area, such as, but not limited to, a home, or a floor of a building.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for cell re-selection, comprising:
identifying candidate cells on at least one frequency, wherein each of the candidate cells is associated with a cell quality;
storing information related to each of the candidate cells in a candidate list;
sorting the candidate list; and
decoding a master information block (MIB) and one or more system information blocks (SIBs) for a subset of the candidate cells based on the sorting.

2. The method of claim 1, wherein the identifying comprises:
determining a first frequency associated with a serving cell;
scanning the first frequency to detect one or more candidate cells; and
scanning one or more frequencies, other than the first frequency, to detect one or more additional candidate cells, wherein each of the one or more additional candidate cells is a strongest cell in a corresponding frequency.

3. The method of claim 1, wherein the storing comprises:
determining whether each of the candidate cells are included in a neighbor cell list;
determining a Qoffset value for each of the candidate cells based on the determining, wherein the Qoffset value is an indication of the cell quality of a candidate cell as compared with a serving cell; and
calculating a ranking for each of the candidate cells based on a corresponding Qoffset value,
wherein the information related to each of the candidate cells includes the ranking for each of the candidate cells, a frequency on which each of the candidate cells were detected, and other cell information for each of the candidate cells.

4. The method of claim 3, wherein the selecting the Qoffset value comprises:
determining that a candidate cell is included in the neighbor cell list; and
reading network-provided information to determine the Qoffset value for the candidate cell.

5. The method of claim 3, wherein the selecting the Qoffset value further comprises:
determining that a candidate cell is not included in the neighbor cell list; and
assuming a value of zero for the Qoffset values.

6. The method of claim 3, wherein the sorting comprises:
sorting the candidate list based on the ranking of each of the candidate cells.

7. The method of claim 3, wherein the decoding comprises:
determining a highest-ranked cell in the candidate list based on the sorting; and
decoding the MIB and the one or more SIBs for the highest-ranked cell.

8. The method of claim 7, further comprising:
determining that the highest-ranked cell is a closed subscriber group (CSG) cell; and
re-selecting to the highest-ranked cell.

9. The method of claim 7, further comprising:
determining that the highest-ranked cell is not a closed subscriber group (CSG) cell;
removing the highest-ranked cell from the candidate list;
determining that the highest-ranked cell was detected based on scanning a first frequency of the serving cell;
determining an actual Qoffset value for the highest-ranked cell; and
re-calculating the ranking of the highest-ranked cell based on the actual Qoffset value.

10. The method of claim 9, further comprising:
determining that the re-calculated ranking of the highest-ranked cell is greater than the ranking of a set of candidate cells that are on the same frequency as the highest-ranked cell; and
removing the set of candidate cells from the candidate list, wherein the decoding further comprises decoding the MIB and the one or more SIBs for the next highest-ranked cell.

11. The method of claim 1, wherein the identifying comprises:
determining a target radio access technology (RAT) that is different from a RAT of a serving cell; and
scanning each frequency associated with the target RAT to detect a strongest candidate cell on each frequency, wherein the storing comprises storing information related to strongest candidate cells detected on each frequency.

12. The method of claim 11, wherein the sorting comprises:
sorting the strongest candidate cells based on the cell quality of each of the strongest candidate cells; and
determining a ranking for each of the strongest candidate cells based on the results of the sorting, wherein the information related to the strongest candidate cells includes the ranking for each of the strongest candidate cells, a frequency on which each of the strongest candidate cells were detected, and other cell information for each of the strongest candidate cells.

13. The method of claim 12, wherein the decoding comprises:
determining a highest-ranked strongest candidate cell in the candidate list; and
decoding the MIB and the one or more SIBs for the highest-ranked strongest candidate cell.

14. The method of claim 13, further comprising:
determining that the highest-ranked strongest candidate cell is a CSG cell based on the decoding; and
re-selecting to the highest-ranked strongest candidate cell.

15. The method of claim 13, further comprising:
determining that the highest-ranked strongest candidate cell is not a CSG cell based on the decoding; and
decoding the MIB and the one or more SIBs for a next highest-ranked strongest candidate cell.

16. A computer program product for cell re-selection, comprising:
a computer readable medium comprising:
code for identifying candidate cells on at least one frequency, wherein each of the candidate cells is associated with a cell quality;
code for storing information related to each of the candidate cells in a candidate list;
code for sorting the candidate list; and
code for decoding a master information block and one or more system information blocks for a subset of the candidate cells based on the sorting.

17. An apparatus for cell re-selection, comprising:
a processing system configured to:
identify candidate cells on at least one frequency, wherein each of the candidate cells is associated with a cell quality;
store information related to each of the candidate cells in a candidate list;
sort the candidate list; and
decode a master information block and one or more system information blocks for a subset of the candidate cells based on the sorting.

18. The apparatus of claim 17, wherein the processing system is configured to store the information by:
determining whether each of the candidate cells are included in a neighbor cell list;
determining a Qoffset value for each of the candidate cells based on the determining, wherein the Qoffset value is an indication of the cell quality of a candidate cell as compared with a serving cell; and
calculating a ranking for each of the candidate cells based on a corresponding Qoffset value,
wherein the information related to each of the candidate cells includes the ranking for each of the candidate cells, a frequency on which each of the candidate cells were detected, and other cell information for each of the candidate cells.

19. The apparatus of claim 18, wherein the processing system is configured to select the Qoffset value by:
determining that a candidate cell is included in the neighbor cell list; and
reading network-provided information to determine the Qoffset value for the candidate cell.

20. The apparatus of claim 18, wherein the processing system is configured to select the Qoffset value by:
determining that a candidate cell is not included in the neighbor cell list; and
assuming a value of zero for the Qoffset.
